(19) United States
(12) Patent Application Publication
(10) Pub. No.: US 2008/0085064 A1
(43) Pub. Date: Apr. 10, 2008

(54) Camera

(76) Inventors: Hideki Nagata, Hachioji-shi (JP); Nobuyuki Watanabe, Yokohama-shi (JP); Minoru Omaki, Kunitachi-shi (JP)

Correspondence Address: KENYON & KENYON LLP, ONE BROADWAY, NEW YORK, NY, 10004, US

(21) Appl. No.: 11/901,816

(22) Filed: Sep. 18, 2007

(30) Foreign Application Priority Data
Sep. 25, 2006 (JP) 2006-258715

(51) Int. Cl. G06K 9/32

(52) U.S. Cl. 382/299

(57) ABSTRACT

It is possible to acquire an image of a human figure in which pores or fine wrinkles cannot be displayed in detail even when the image is enlarged by image processing, and acquire an image of a distant view or a distant human figure in which enlarged portions can also be displayed in detail by image processing. The invention provides a camera including an image-acquisition unit for acquiring an image; a magnification detection unit for detecting an imaging magnification; and an image adjusting unit for changing at least one of resolution and contrast of the image acquired by the image-acquisition unit, wherein the image adjusting unit adjusts to a predetermined resolution or contrast that are lower than the resolution or contrast capable of being acquired by the image-acquisition unit when the imaging magnification detected by the magnification detection unit is larger than a predetermined magnification.

### BACKGROUND OF THE INVENTION

1. Field of the Invention

The present invention relates to a camera.

This application is based on Japanese Patent Application No. 2006-258715, the content of which is incorporated herein by reference.

2. Description of Related Art

In the related art, there is a known camera for subjecting an acquired image to skin-color correction when taking photographs in a human-figure (portrait) photography mode (for example, see Japanese Unexamined Patent Application, Publication No. 2004-61762).

Recently, the resolution of digital cameras is extremely high; therefore, an image acquired in normal image acquisition can be clearly enlarged, even for finely detailed portions, by subsequent image processing.

### BRIEF SUMMARY OF THE INVENTION

A first aspect is a camera including an image-acquisition unit for acquiring an image; a magnification detection unit for detecting an imaging magnification; and an image adjusting unit for changing at least one of resolution and contrast of the image acquired by the image-acquisition unit, wherein the image adjusting unit adjusts to a predetermined resolution or contrast that are lower than the resolution or contrast capable of being acquired by the image-acquisition unit when the imaging magnification detected by the magnification detection unit is larger than a predetermined magnification.

A second aspect is the camera according to the first aspect, wherein the image-acquisition unit includes an image-acquisition device in which a large number of pixels are two-dimensionally arrayed; and the image adjusting unit adjusts the resolution or contrast based on a normalized imaging magnification obtained by dividing the imaging magnification detected by the magnification detection unit by a pixel pitch of the image-acquisition device.

A third aspect is the camera according to the first aspect, wherein the image-acquisition unit includes an image-acquisition device in which a large number of pixels are two-dimensionally arrayed; and the image adjusting unit processes the image acquired by the image-acquisition device, detects the size of a subject face on the image, and adjusts the resolution or contrast when 50,000 pixels or more are allocated to the detected size of the subject face on the image.

### BRIEF DESCRIPTION OF THE SEVERAL VIEWS OF THE DRAWINGS

FIG. 1 is a block diagram showing a camera.

FIG. 2 is a flow chart explaining a process performed by the camera in FIG. 1.

FIG. 3 is a diagram showing an example image of a reference subject when it is determined whether or not image processing is to be performed by the camera in FIG. 1.

FIG. 4 is a flow chart explaining a process performed by a modification of the camera in FIG. 1.

### DETAILED DESCRIPTION OF THE INVENTION

A camera according to the present invention includes an image-acquisition unit for acquiring an image; a magnification detection unit for detecting an imaging magnification; and an image adjusting unit for changing at least one of resolution and contrast of the image acquired by the image-acquisition unit, wherein the image adjusting unit adjusts to a predetermined resolution or contrast that are lower than the resolution or contrast capable of being acquired by the image-acquisition unit when the imaging magnification detected by the magnification detection unit is larger than a predetermined magnification.

According to this camera, when the imaging magnification detected by operating the magnification detection unit is larger than a predetermined magnification, the resolution or contrast of the image acquired by the image-acquisition unit can be reduced by operating the image adjusting unit. On the other hand, when the imaging magnification detected by the magnification detection unit is equal to the predetermined magnification or less, as the image acquired by the image-acquisition unit, it is possible to acquire an image with the maximum resolution or contrast that can be acquired by the image-acquisition unit, by operating the image adjusting unit.

In this way, when a portrait photography mode or the like for acquiring a relatively large human figure relative to a picture frame is selected, the detected imaging magnification is large; and when a photography mode or the like for acquiring a distant object is selected, the imaging magnification detected is small. Accordingly, by adjusting the resolution or contrast of the image to be acquired based on whether or not the imaging magnification is large compared to a predetermined threshold value, in the case of an image of a human figure, it is possible to acquire an image in which detailed portions cannot be finely displayed, even when it is enlarged; and in the case of an image of a distant image and the like, it is possible to acquire a detailed image showing even the sex and face of a distant human figure, when it is enlarged.

In the camera described above, the image-acquisition unit may include an image-acquisition device in which a large number of pixels are two-dimensionally arrayed; and the image adjusting unit may adjust the resolution or contrast based on a normalized imaging magnification obtained by dividing the imaging magnification detected by the magnification detection unit by a pixel pitch of the image-acquisition device.

By doing so, even when the value of the imaging magnification differs due to the image-acquisition device size or the like, it is possible to assign substantially the same normalized reference value to all image-acquisition devices by dividing by the pixel pitch of the image-acquisition device.

In the camera described above, the image-acquisition unit may include an image-acquisition device in which a large number of pixels are two-dimensionally arrayed; and the image adjusting unit may process the image acquired by the image-acquisition device, detect the size of a subject face on the image, and adjust the resolution or contrast when 50,000 pixels or more are allocated to the detected size of the subject face on the image.

By doing so, when 50,000 pixels or more are allocated as a face region in the image, since there is a possibility that the image will be enlarged and displayed in detail, even including minute portions, by subsequent image processing, it is effective to reduce the resolution or contrast in such a case.

The camera described above affords an advantage in that it is possible to acquire an image of a human figure in which pores or fine wrinkles cannot be displayed in detail even when the image is enlarged by image processing, and acquire an image of a distant view or a distant human figure in which enlarged portions can be displayed in detail by image processing.

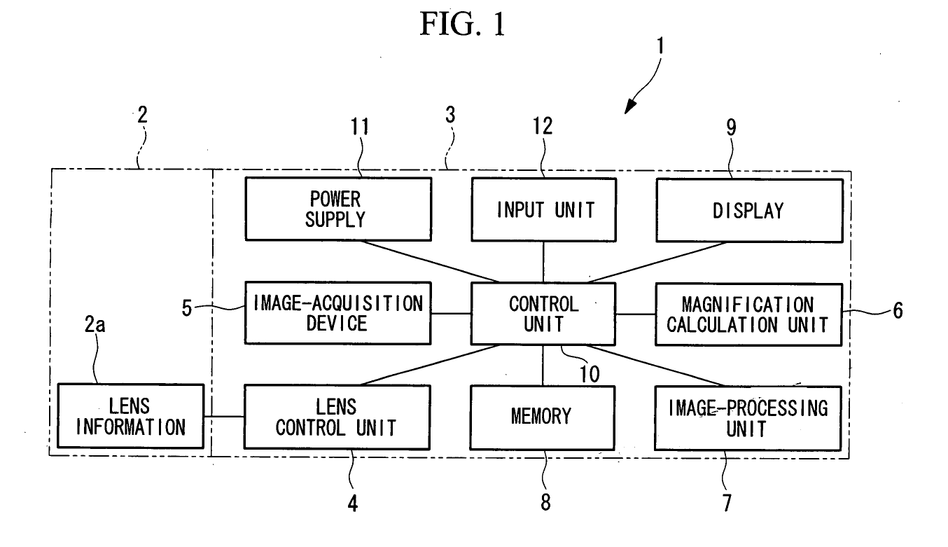

A camera 1 will be described below with reference to FIGS. 1 to 3.

The camera 1 includes a lens unit 2 and a camera body 3. The lens unit 2 may be removable or may be integrally formed with the camera body 3. The lens unit 2 has a function for acquiring an image of a subject and includes a storage unit 2a for storing information, such as properties of a lens.

The camera body 3 includes a lens control unit 4 for controlling the lens unit 2, an image-acquisition device 5 for converting an image of a subject acquired by the lens unit 2 to electrical image data, a magnification calculation unit 6 for calculating an imaging magnification, an image-processing unit 7 for subjecting the image data acquired by the image-acquisition device 5 to predetermined image processing, a memory 8 for storing the processed image data, a display 9, such as a liquid crystal display, for displaying the processed image data, and a control unit 10 for controlling them. Reference numeral 11 in the drawing is a power supply, and reference numeral 12 is an input unit such as a release button.

The lens control unit 4 is an autofocus mechanism to move the lens unit 2 so that a focal position of the lens unit 2 for the subject is aligned with an image-acquisition surface of the image-acquisition device 5. For example, the lens control unit 4 detects a contrast value by processing an image acquired by the image-acquisition device 5, and moves the lens unit 2 so that the detected contrast value is maximum.

The image-acquisition device 5 is a device, such as a CCD, in which a number of pixels are two-dimensionally arrayed with a predetermined pixel pitch.

As a result of moving the lens unit 2, the magnification calculation unit 6 calculates a rough imaging magnification by calculating a subject distance based on the position of the lens unit 2 where the contrast value is maximum, and dividing the focal length (already known) of the lens unit 2 by the subject distance.

The control unit 10 calculates a normalized imaging magnification by dividing the imaging magnification calculated by the magnification calculation unit 6 by the pixel pitch of the image-acquisition device 5 and compares it with a predetermined threshold value. As a result of the comparison, when the normalized imaging magnification is equal to the predetermined threshold value or above, image processing, such as soft focus processing, for reducing the resolution or contrast is performed; and when the normalized imaging magnification is smaller than the predetermined threshold value, the image is not processed.

The image data, which is processed or not processed depending on the normalized imaging magnification, is displayed on the display 9 by the control unit 10 and is stored in the memory 8.

Now, the normalized imaging magnification will be described with reference to Table 1.

TABLE 1

| | | | | | REQUIRED | | |
|---|---|---|---|---|---|---|---|
| IMAGE-ACQUISITION DEVICE | | | | | NUMBER OF | | |
| | TOTAL | | | | PIXELS FOR | | NORMALIZED |
| | NUMBER OF | | DIAGONAL | PIXEL | IMAGE | IMAGING | IMAGING |
| | PIXELS | AREA | LENGTH | PITCH | PROCESSING | MAGNIFICATION | MAGNIFICATION |
| A | 10M | 864.0 | 43.3 | 0.0093 | 50000 | 0.01530 | 1.64 |
| B | 40M | 864.0 | 43.3 | 0.0046 | 50000 | 0.00765 | 1.64 |
| C | 10M | 390.8 | 28.7 | 0.0063 | 50000 | 0.01016 | 1.62 |
| D | 10M | 224.9 | 21.6 | 0.0047 | 50000 | 0.00765 | 1.61 |
| E | 4M | 58.1 | 11.0 | 0.0038 | 50000 | 0.00615 | 1.61 |
| F | 4M | 30.7 | 8.0 | 0.0028 | 50000 | 0.00447 | 1.61 |
| G | 4M | 17.3 | 6.0 | 0.0021 | 50000 | 0.00335 | 1.61 |

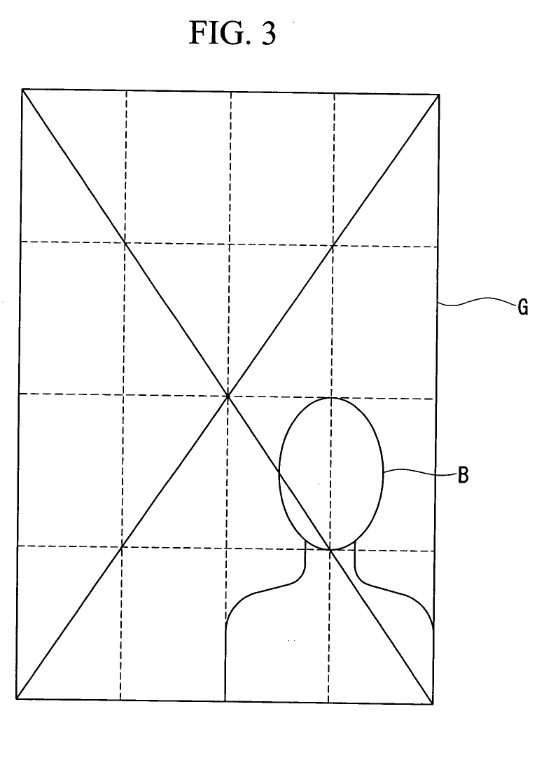

In general, when an image acquired by a digital camera is printed on L-size printing paper (3.5″×5″, or 89×127 mm) with about 200 dpi resolution, about 700,000 pixels of information is required. In this case, as shown in FIG. 3, when a human figure B, which is a subject, occupies about ¼ of the whole image G in a bust-up portrait, it is clearly printed out by a printer.

In this case, the face of the human figure B occupies about 1/16 of the whole image G. In other words, when the face on the image occupies 43,750 pixels, that is, 1/16 of 700,000 pixels, i.e., about 50,000 pixels (hereinafter, referred to as a required number of pixels for image processing), an enlarged detailed portion can be displayed without soft focus processing. This 50,000 pixels applies to any image-acquisition device having any size and number of pixels.

For some image-acquisition devices 5 (A to G), the normalized imaging magnification is calculated by obtaining a diagonal length of a rectangular region that the required number of pixels for image processing occupies, calculating a dummy imaging magnification obtained by dividing by the diagonal length of the actual face of the human figure (minimum 200 mm), and further dividing that imaging magnification by the pixel pitch. The diagonal length is used here because the aspect ratio of the pixels varies depending on the type of image-acquisition device 5. Accordingly, the aspect ratio is defined by a single diagonal length instead of the length and width of the region.

According to Table 1, the normalized imaging magnification is about 1.6 regardless of the type of image-acquisition device 5 (A to G).

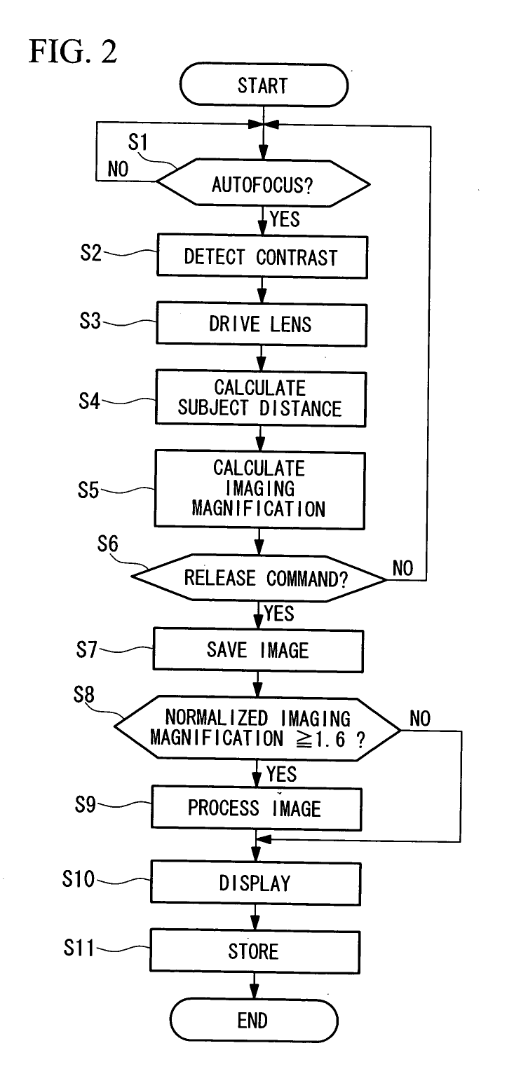

The operation of the camera 1 having such a configuration will be described using a flow chart in FIG. 2.

First, when photographing starts, it is determined whether or not autofocus is required (step S1). When the autofocus is required, an image acquired by the image-acquisition device 5 is processed and a contrast value is detected (step S2).

After that, the lens control unit 4 controls and drives the lens unit 2 to search for a position where the contrast value is maximum (step S3).

In this state, when the lens unit 2 is moved to the position where the contrast value is maximum, the subject distance is calculated by the magnification calculation unit 6 (step S4), and the imaging magnification is calculated based on the calculated subject distance and the focal length of the lens unit 2 (step S5).

It is then determined whether or not a release command is input from the input unit 12 (step S6), and when the release command is input, the image data acquired by the image-acquisition device 5 at that time is saved (step S7). When the release command is not input, steps S1 to S5 are repeated.

At this time, the control unit calculates the normalized imaging magnification by dividing the calculated imaging magnification by the pixel pitch of the image-acquisition device 5, which is stored in advance, and determines whether or not the normalized imaging magnification is equal to 1.6 or above (step S8). If, as a result, the normalized imaging magnification is 1.6 or above, image processing, such as soft focus processing, is performed on the saved image data (step S9).

The processed image data is then displayed on the display 9 (step S10) and is stored in the memory 8 (step S11). When the normalized imaging magnification is less than 1.6, the displaying step S10 and the storing step S11 are executed without subjecting the stored image data to processing that reduces the resolution or contrast, such as soft focus processing.

In this way, the camera 1 performs the soft focus processing and displays and stores the processed image when the normalized imaging magnification is equal to 1.6 or above, that is, when the imaging magnification results in 50,000 pixels or more being allocated to the image of the subject face. Accordingly, it is possible to prevent the problem of details such as pores or fine wrinkles on the face being displayed when they are magnified later by the image processing.

On the other hand, when the normalized imaging magnification is less than 1.6, that is, the imaging magnification results in 50,000 pixels or more not being allocated to the image of the subject face, the raw image which is not subjected to soft focus processing is displayed and stored. Accordingly, a human figure or the like which appears small when at a distance can be displayed in detail when it is enlarged later by the image processing.

In this embodiment, it is determined whether or not the soft focus processing is performed based on whether or not the normalized imaging magnification is equal to the predetermined threshold of 1.6 or above. Instead of this, a 1.6×pixel pitch is stored as a threshold value, and it may be determined based on whether or not the calculated imaging magnification is equal to or greater than the threshold value.

In addition, it may be determined, by the image-processing unit, whether or not to perform the soft focus processing by recognizing the image of the face in the image acquired by the image-acquisition device, calculating the size thereof, and directly determining whether or not 50,000 pixels or more are allocated to the image of the face.

The required number of pixels for image processing is not limited to 50,000 pixels. It may arbitrarily be selected to be about 40,000 to 60,000 pixels. Thus, the normalized imaging magnification of 1.6 can also be suitably adjusted in accordance therewith.

In this embodiment, a case using a contrast detection method as the autofocus method for calculating the subject distance is described. Instead of this, however, the subject distance may be calculated using a phase-difference detection method.

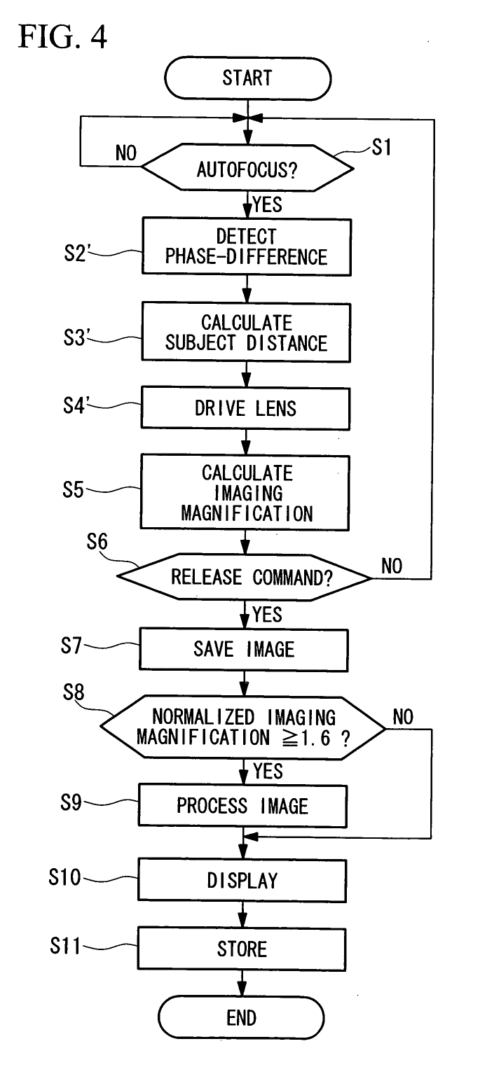

In this case, as shown in FIG. 4, first, a phase-difference signal is detected by a range sensor (not shown in the drawing) (step S2′), the subject distance is calculated based on the detected phase-difference signal (step S3′), and the lens unit 2 is driven to focus it (step S4′). Other steps from S5 to S11 are the same as those in the contrast method.

As a result, an advantage is afforded in that the subject distance can be quickly calculated compared to the contrast detection method.

What is claimed is:

1. A camera comprising:
an image-acquisition unit for acquiring an image;
a magnification detection unit for detecting an imaging magnification; and
an image adjusting unit for changing at least one of resolution and contrast of the image acquired by the image-acquisition unit, wherein
the image adjusting unit adjusts to a predetermined resolution or contrast that are lower than the resolution or contrast capable of being acquired by the image-acquisition unit when the imaging magnification detected by the magnification detection unit is larger than a predetermined magnification.

2. A camera according to claim 1, wherein
the image-acquisition unit includes an image-acquisition device in which a large number of pixels are two-dimensionally arrayed; and
the image adjusting unit adjusts the resolution or contrast based on a normalized imaging magnification obtained by dividing the imaging magnification detected by the magnification detection unit by a pixel pitch of the image-acquisition device.

3. A camera according to claim 1, wherein
the image-acquisition unit includes an image-acquisition device in which a large number of pixels are two-dimensionally arrayed; and
the image adjusting unit processes the image acquired by the image-acquisition device, detects the size of a subject face on the image, and adjusts the resolution or contrast when 50,000 pixels or more are allocated to the detected size of the subject face on the image.
